(19) United States
(12) Patent Application Publication
(10) Pub. No.: US 2016/0305507 A1
(43) Pub. Date: Oct. 20, 2016

(54) ROTARY UNITS, ROTARY MECHANISMS, AND RELATED APPLICATIONS

(71) Applicant: Christopher C. Sappenfield, San Diego, CA (US)

(72) Inventor: Christopher C. Sappenfield, San Diego, CA (US)

(73) Assignee: Christopher C. Sappenfield, San Diego, CA (US)

(21) Appl. No.: 15/194,761

(22) Filed: Jun. 28, 2016

Related U.S. Application Data
(63) Continuation-in-part of application No. 14/327,519, filed on Jul. 9, 2014, now Pat. No. 9,382,973.
Application No. 14/327,519 is a continuation of application No. 14/187,302, filed on Feb. 23, 2014, now Pat. No. 8,956,258.
Application No. 14/187,302 is a continuation of application No. 13/451,468, filed on Apr. 19, 2012, now Pat. No. 8,684,883.
Application No. 13/451,468 is a continuation-in-part of application No. 13/423,413, filed on Mar. 19, 2012, now Pat. No. 8,672,799.
Application No. 13/423,413 is a continuation-in-part of application No. 13/219,683, filed on Aug. 28, 2011, now Pat. No. 8,715,133.
Application No. 13/219,683 is a continuation-in-part of application No. 13/184,332, filed on Jul. 15, 2011, now Pat. No. 8,668,618.
Application No. 13/184,332 is a continuation-in-part of application No. 12/577,326, filed on Oct. 12, 2009, now Pat. No. 8,152,679.
Application No. 12/577,326 is a continuation of application No. PCT/US09/60386, filed on Oct. 12, 2009.
(60) Provisional application No. 61/365,290, filed on Jul. 16, 2010.
(60) Provisional application No. 61/376,725, filed on Aug. 25, 2010.
(60) Provisional application No. 61/104,748, filed on Oct. 12, 2008.
(60) Provisional application No. 62/186,229, filed on Jun. 29, 2015.

(51) Int. Cl. F16H 1/20; A61C 1/18; A61C 17/26

(52) U.S. Cl. CPC F16H 1/20; A61C 17/26; A61C 1/185

(57) ABSTRACT

The invention relates to devices including rotary units and rotary mechanisms that are suitable for use in numerous applications. Rotary units typically include rotational components that are configured to rotate. In some embodiments, for example, multiple rotary units are assembled in rotary mechanisms such that neighboring pairs of rotational components counter-rotate or contra-rotate relative to one another during operation of the rotary mechanisms. Rotational components generally include one or more implements that are structured to perform or effect one or more types of work as the rotational components rotate relative to one another in a given rotary mechanism. In certain embodiments, implements are configured to rotate and/or to effect the movement of other components as rotational components rotate.

### CROSS-REFERENCE TO RELATED APPLICATIONS

This application is a continuation-in-part of, and claims the benefit of priority from, U.S. Non-Provisional patent application Ser. No. 14/327,519, filed Jul. 9, 2014, which is a continuation of, and claims the benefit of priority from, U.S. Non-Provisional patent application Ser. No. 14/187,302, filed Feb. 23, 2014 (now U.S. Pat. No. 8,956,258, issued Feb. 17, 2015), which is a continuation of, and claims the benefit of priority from, U.S. Non-Provisional patent application Ser. No. 13/451,468, filed Apr. 19, 2012 (now U.S. Pat. No. 8,684,883, issued Apr. 1, 2014), which is a continuation-in-part of, and claims the benefit of priority from, U.S. Non-Provisional patent application Ser. No. 13/423,413, filed Mar. 19, 2012 (now U.S. Pat. No. 8,672,799, issued Mar. 18, 2014), which is a continuation-in-part of, and claims the benefit of priority from U.S. Non-Provisional patent application Ser. No. 13/219,683, filed Aug. 28, 2011 (now U.S. Pat. No. 8,715,133, issued May 6, 2014), which is a continuation-in-part of, and claims the benefit of priority from U.S. Non-Provisional patent application Ser. No. 13/184,332, filed Jul. 15, 2011 (now U.S. Pat. No. 8,668,618, issued Mar. 11, 2014), which claims the benefit of priority from U.S. Provisional Patent Application No. 61/365,290, filed Jul. 16, 2010 and 61/376,725, filed Aug. 25, 2010, which are each incorporated by reference in their entirety. U.S. Non-Provisional patent application Ser. No. 13/184,332, filed Jul. 15, 2011 (now U.S. Pat. No. 8,668,618, issued Mar. 11, 2014) is also continuation-in-part of, and claims the benefit of priority from, U.S. Non-Provisional patent application Ser. No. 12/577,326, filed Oct. 12, 2009 (now U.S. Pat. No. 8,152,679, issued Apr. 10, 2012), which claims the benefit of priority from U.S. Provisional Patent Application No. 61/104,748, filed on Oct. 12, 2008 and is a continuation of and claims the benefit of priority from International Patent Application No. PCT/US09/60386, filed on Oct. 12, 2009, which are each incorporated by reference in their entirety. This application also claims the benefit of priority from U.S. Provisional Patent Application No. 62/186,229, filed Jun. 29, 2015, which is incorporated by reference in its entirety.

### FIELD OF THE INVENTION

The invention relates generally to mechanical, electrical, or electromechanical devices, and provides rotary units, rotary mechanisms, methods, and related devices and other applications that are useful for a wide variety of purposes.

### BACKGROUND OF THE INVENTION

Electromechanical devices are ubiquitous. Some of these devices include rotating components and are used in many different applications. Gardening tools such as rotor tillers, for example, typically include rotating rotors having tines, which contact the soil during operation. Many other devices of use in agricultural and construction, among many other fields or applications also utilize various types of rotational components to achieve desired forms of work.

### SUMMARY OF THE INVENTION

In one aspect, the invention provides a rotary mechanism that includes at least first and second rotary units that each comprise at least one rotational component, which rotational component comprises at least a first portion and is configured to comprise at least a second portion, wherein the first and/or second portion comprises at least one attachment component or portion thereof that is configured to reversibly attach the first and second portions to one another, and wherein at least one of the second portions comprises at least one implement. In some embodiments, for example, second portions comprise snap-on prophy cups, snap-on bristle heads, latch-type prophy cups, latch-type bristle heads, screw-on prophy cups, screw-on bristle heads, and the like. The rotary mechanism also includes at least a first counter-rotational mechanism that operably engages at least the first portions of the first and second rotary units. In addition, the rotary mechanism also includes at least one drive mechanism component or a portion thereof that operably engages one or more of the first and second rotary units and/or the first counter-rotational mechanism, which drive mechanism component or portion thereof is configured to effect movement of at least the first portions of the first and second rotary units and first counter-rotational mechanism such that at least the first portion of the first rotary unit rotates in a first direction and at least the first portion of the second rotary unit rotates in a second direction. In some embodiments, the rotary mechanism includes more than two rotary units. In certain embodiments, the rotational components or portions thereof are configured to rotate substantially non-concentric relative to one another. In some embodiments, the rotational components each comprise at least one gear component, wherein the gear component of at least a first rotational component operably engages the gear component of at least a second rotational component.

In certain embodiments, the rotary mechanism includes the second portions. In some embodiments, each of the second portions comprises one or more implements. In some embodiments, at least one of the second portions lacks one or more implements (e.g., is a blank second portion). In certain embodiments, at least one of the first and second portions comprises at least one retaining mechanism or portion thereof that is configured to retain the second portion in position relative to the first portion when the second portion is reversibly attached to the first portion. In some embodiments, at least a portion of the implement comprises at least one cross-sectional shape selected from the group consisting of: a circle, an oval, a square, a rectangle, a trapezoid, an irregular n-sided polygon, and a regular n-sided polygon. In certain embodiments, the implement is rotatably coupled to the second portion. In some embodiments, for example, second portions comprise snap-on prophy cups, snap-on bristle heads, latch-type prophy cups, latch-type bristle heads, screw-on prophy cups, screw-on bristle heads, and the like. In certain embodiments, at least one of the rotational components comprises at least one resilient coupling that resiliently couples at least a first segment of the rotational component to at least a second segment of the rotational component. In some embodiments, at least a first rotational component is configured to rotate at least partially around a first rotational axis and wherein at least a second rotational component is configured to rotate at least partially around a second rotational axis. In some embodiments, at least a first rotational component is configured to rotate at least 360° around a first rotational axis and wherein at least a second rotational component is configured to rotate at least 360° around a second rotational axis. In some of these embodiments, the second portion comprises at least one surface that is configured to rotate substantially perpendicular to the at least one of rotational axes. In some embodiments, each of the second portions comprises one or more implements. In some of these embodiments, one or more of the implements of at least one second portion differ one or more of the implements of at least one other second portion.

In some embodiments, the attachment component or portion thereof comprises latch components that are configured to engage one another to reversibly attach the first and second portions to one another. In some embodiments, the attachment component or portion thereof comprises compression mechanism components that are configured to engage one another to reversibly attach the first and second portions to one another. In certain embodiments, the attachment component or portion thereof comprises at least one tapered projection component and at least one recess component, wherein the tapered projection and recess components are configured to interlock with one another to reversibly attach the first and second portions to one another. In some of these embodiments, the tapered projection component comprises at least one tenon or at least one dovetail joint component and the recess component comprises at least one mortise or at least one dovetail joint component. In some embodiments, the attachment component or portion thereof comprises at least one external thread component and at least one internal thread component, wherein the internal thread component is configured to receive the external thread component to reversibly attach the first and second portions to one another. In some of these embodiments, the first portion comprises the external thread component and the second portion comprises the internal thread component.

In certain embodiments, the drive mechanism component or a portion thereof comprises at least one chain of meshed gear components that is configured to effect the movement of the first portions of the first and second rotary units. In some embodiments, the drive mechanism component or portion thereof comprises at least one shaft component that operably engages at least the rotary mechanism or a portion thereof. In some embodiments, the drive mechanism component or portion thereof is configured to oscillate at least one of the rotational components. In some embodiments, at least the first counter-rotational mechanism comprises at least a first gear component disposed on the first portion of a first rotational component and at least a second gear component disposed on the first portion of a second rotational component, wherein the first and second gear components operably engage one another such that when the first gear component rotates in the first direction, the first portion of the first rotational component rotates in the first direction and the second gear component and the first portion of a second rotational component rotate in the second direction. In some of these embodiments, the drive mechanism component or a portion thereof comprises at least one chain of meshed gear components that operably engages the first and/or second gear components. In some embodiments, the drive mechanism component or a portion thereof comprises at least one positioning mechanism configured such that at least one portion of the drive mechanism component is selectively positioned relative to the first and/or second rotary units. In some of these embodiments, the positioning mechanism comprises at least one universal joint.

In some embodiments, a dental device includes the rotary mechanism. In certain embodiments, a vehicle includes the rotary mechanism. In some embodiments, a device includes the rotary mechanism. In some of these embodiments, the device is selected from, for example, a hand-held device, a rototiller, a hair cutting device, a massaging device, nail grooming device, a propulsion device, a woodworking device, a lathe, a woodchipping device, a machining device, a dermabrasion device, a medical device, a dental device, a cleaning device, an engine, a snowblower, a nozzle, a food preparation device, a grinder, a pencil sharpener, a lawn mower, a vacuum cleaner, a hair dryer, a plumbing device, a weapon, a surfboard, a scuba device, a component thereof, and a combination thereof.

In another aspect, the invention provides a rotary mechanism that includes at least first and second rotary units that each comprise at least one rotational component, wherein one or more of the rotational components comprises at least a first portion and is configured to comprise at least a second portion, wherein the first and/or second portion comprises at least one attachment component or portion thereof that is configured to reversibly attach the first and second portions to one another, and wherein at least one of the rotational components or portion thereof comprises at least one implement. The rotary mechanism also includes at least a first counter-rotational mechanism that operably engages at least the rotational components or portion thereof of the first and second rotary units. In addition, the rotary mechanism also includes at least one drive mechanism component or a portion thereof that operably engages one or more of the first and second rotary units and/or the first counter-rotational mechanism, which drive mechanism component or portion thereof is configured to effect movement of at least the rotational components or portion thereof and the first counter-rotational mechanism such that the rotational component or portion thereof of the first rotary unit rotates in a first direction and the rotational component or portion thereof of the second rotary unit rotates in a second direction. In some embodiments, the drive mechanism component or portion thereof comprises at least one chain of meshed gear components.

In another aspect, the invention provides a handheld device that includes a head portion comprising at least one rotary mechanism that comprises at least two rotational components, wherein each of the rotational components comprises at least a first portion and is configured to comprise at least a second portion, wherein the first and/or second portion comprises at least one attachment component or portion thereof that is configured to reversibly attach the first and second portions to one another, wherein at least a first rotational component is configured to rotate at least partially around a first rotational axis, wherein at least a second rotational component is configured to rotate at least partially around a second rotational axis, and wherein at least one of the second portions comprises at least one implement. The handheld device also includes at least one drive mechanism component or portion thereof that operably engages, or is configured to operably engage, at least the rotary mechanism, which drive mechanism component or portion thereof is configured to effect rotation of at least a portion of the first rotational component at least partially around the first rotational axis in a first direction and at least a portion of the second rotational component at least partially around the second rotational axis in a second direction. In some embodiments, the drive mechanism component or portion thereof is configured to effect rotation of at least a portion of the first rotational component at least 360° around the first rotational axis in a first direction and at least a portion of the second rotational component at least 360° around the second rotational axis in a second direction. In addition, the handheld device also includes a handle portion operably connected or connectable to the head portion.

In some embodiments, the drive mechanism component or a portion thereof comprises at least one positioning mechanism configured such that the head and handle portions are selectively positioned relative to one another. In some embodiments, the positioning mechanism comprises at least one universal joint. In some embodiments, the second portions that comprise the implement comprise at least one surface that is configured to rotate substantially perpendicular to the at least one of rotational axes, which surface comprises the implement. In certain embodiments, the drive mechanism component or portion thereof is configured to effect reversible rotation of at least one of the rotational components at least partially around at least one of the rotational axes. In some embodiments, the handle portion comprises at least part of the drive mechanism component or portion thereof. In some embodiments, the head and handle portions are detachable from one another. In some embodiments, a tooth brushing device or a cleaning device comprising the handheld device.

In another aspect, the invention provides a rotational component portion that includes at least first body structure portion that comprises at least one attachment component or portion thereof that is configured to reversibly attach the first body structure portion to at least a second body structure portion, which second body structure portion comprises at least one gear component that is configured to operably engage at least one other gear component of another rotation component. The rotational component portion also includes at least one implement operably connected to the first body structure portion. In certain embodiments, the attachment component or portion thereof comprises at least one tapered projection component and at least one recess component, wherein the tapered projection and recess components are configured to interlock with one another to reversibly attach the first and second body structure portions to one another.

In another aspect, the invention provides a dental device that includes a head portion comprising at least one component that comprises at least one implement and a handle portion operably connected or connectable to the head portion. The dental device also includes at least one drive mechanism component or portion thereof that operably engages, or is configured to operably engage, at least the component, which drive mechanism component or portion thereof is configured to effect movement of at least a portion of the component, wherein the drive mechanism component or portion thereof comprises at least one positioning mechanism configured such that the head and handle portions are selectively positioned relative to one another.

In another aspect, the invention provides a dental device that includes a head portion comprising at least one rotational component that comprises at least one implement and a handle portion operably connected or connectable to the head portion. The dental device also includes at least one drive mechanism component or portion thereof that operably engages, or is configured to operably engage, at least the rotational component, which drive mechanism component or portion thereof is configured to effect rotation of at least a portion of the rotational component at least partially around at least one rotational axis, wherein the drive mechanism component or portion thereof comprises at least one positioning mechanism configured such that the head and handle portions are selectively positioned relative to one another. In some embodiments, the head portion comprises at least one rotary mechanism that comprises at least two rotational components, wherein each of the rotational components comprises at least a first portion and is configured to comprise at least a second portion, wherein the first and/or second portion comprises at least one attachment component or portion thereof that is configured to reversibly attach the first and second portions to one another, wherein at least a first rotational component is configured to rotate at least partially around a first rotational axis, wherein at least a second rotational component is configured to rotate at least partially around a second rotational axis, and wherein at least one of the second portions comprises the implement.

In another aspect, the invention provides a method of making a rotary mechanism. The method includes placing at least one counter-rotational mechanism into operable engagement with at least first and second rotational components, wherein the rotational components each comprise at least a first portion and are configured to comprise at least a second portion, wherein the first and/or second portion comprises at least one attachment component or portion thereof that is configured to reversibly attach the first and second portions to one another, and wherein at least one of the second portions comprises at least one implement. The method also includes placing at least one drive mechanism component or a portion thereof into operable engagement with one or more of the rotational components and/or with the counter-rotational mechanism, which drive mechanism component or portion thereof is configured at least to effect rotation of the rotational components such that the first rotational component rotates in a first direction and the second rotational component rotates in a second direction, thereby making the rotary mechanism.

### BRIEF DESCRIPTION OF THE DRAWINGS

The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown.

FIGS. 1A-C schematically illustrate a rotational component, or portions thereof, that include at least one resilient coupling from side views according to one exemplary embodiment of the invention. FIGS. 1 A and B are shown from partial sectional side views.

FIGS. 2A-C schematically illustrate a rotational component, or portions thereof, that include at least one resilient coupling from side views according to one exemplary embodiment of the invention. FIGS. 2 A and B are shown from partial sectional side views.

FIGS. 3A-C schematically illustrate a rotational component, or portions thereof, that include at least one resilient coupling from side views according to one exemplary embodiment of the invention. FIGS. 3 A and B are shown from partial sectional side views.

FIGS. 4A-C schematically illustrate a rotational component, or portions thereof, that include at least one resilient coupling from side views according to one exemplary embodiment of the invention.

FIGS. 5A-C schematically illustrate a rotational component, or portions thereof, that include at least one resilient coupling from side views according to one exemplary embodiment of the invention.

FIGS. 6A-D schematically illustrate a rotational component, or portions thereof, that include at least one resilient coupling from side views according to one exemplary embodiment of the invention.

FIGS. 7A-D schematically illustrate a rotational component, or portions thereof, that include at least one resilient coupling from side views according to one exemplary embodiment of the invention.

FIGS. 8A-D schematically illustrate a rotational component, or portions thereof, that include at least one resilient coupling from side views according to one exemplary embodiment of the invention.

FIGS. 9A-D schematically illustrate a rotational component, or portions thereof, that include at least one resilient coupling from side views according to one exemplary embodiment of the invention.

FIGS. 10A-E schematically illustrate a rotational component, or portions thereof, that include at least one resilient coupling from side views according to one exemplary embodiment of the invention.

FIGS. 11A-D schematically illustrate a rotational component, or portions thereof, that includes first and second portions with attachment components (shown as external and internal threaded components) from various views according to one exemplary embodiment of the invention. FIG. 11A schematically depicts the first and second portions from a side view prior to assembly. FIG. 11B schematically depicts the second portion from a bottom view. FIG. 11C schematically depicts the first portion from a top view. FIG. 11D schematically depicts assembled first and second portions from a side view.

FIGS. 12A-E schematically illustrate a rotational component, or portions thereof, that includes first and second portions with attachment components (shown as compression mechanism components) from various views according to one exemplary embodiment of the invention. FIG. 12A schematically depicts the first and second portions from a side view prior to assembly. FIG. 12B schematically depicts the second portion from a bottom view. FIG. 12C schematically depicts the first portion from a top view. FIG. 12D schematically depicts assembled first and second portions from a side view. FIG. 12E schematically depicts assembled first and second portions from a broken view.

FIGS. 13A-H schematically illustrate a rotational component, or portions thereof, that includes first and second portions with attachment components (shown as latch components) from various views according to one exemplary embodiment of the invention. FIG. 13A schematically depicts the first and second portions from a side view prior to assembly. FIG. 13B schematically depicts the first and second portions from a partial sectional side view prior to assembly. FIG. 13C schematically depicts the second portion from a bottom view. FIG. 13D schematically depicts the first portion from a top view. FIG. 13E schematically depicts assembled first and second portions from a side view. FIG. 13F schematically depicts first and second portions from a partial sectional side view. FIG. 13G schematically depicts first and second portions from a broken view prior to assembly. FIG. 13H schematically depicts assembled first and second portions from a broken view.

FIGS. 14A-E schematically illustrate a rotational component, or portions thereof, that includes first and second portions with attachment components (shown as external and internal threaded components) from various views according to one exemplary embodiment of the invention. FIG. 14A schematically depicts the first and second portions from a side view prior to assembly. FIG. 14B schematically depicts the second portion from a bottom view. FIG. 14C schematically depicts the first portion from a top view. FIG. 14D schematically depicts assembled first and second portions from a side view. FIG. 14E schematically depicts the rotational component a top view (shown as a blank).

FIGS. 15A-F schematically illustrate a rotational component, or portions thereof, that includes first and second portions with attachment components (shown as tapered projection and recess components) from various views according to one exemplary embodiment of the invention. FIG. 15A schematically depicts the first and second portions from a side view prior to assembly. FIG. 15B schematically depicts the second portion from a bottom view. FIG. 15C schematically depicts the first portion from a top view. FIG. 15D schematically depicts the first and second portions from a partial sectional side view prior to assembly. FIG. 15E schematically depicts assembled first and second portions from a side view. FIG. 15F schematically depicts assembled first and second portions from a partial sectional side view.

FIGS. 16A-E schematically illustrate a rotational component, or portions thereof, that includes first and second portions with attachment components (shown as compression mechanism components) from various views according to one exemplary embodiment of the invention. FIG. 16A schematically depicts the first and second portions from a side view prior to assembly. FIG. 16B schematically depicts the second portion from a top view. FIG. 16C schematically depicts the second portion from a bottom view. FIG. 16D schematically depicts the first portion from a top view. FIG. 16E schematically depicts assembled first and second portions from a side view.

FIGS. 17A-D schematically illustrate a rotational component, or portions thereof, that includes first and second portions with attachment components (shown as compression mechanism components) from various views according to one exemplary embodiment of the invention. FIG. 17A schematically depicts the first and second portions from a side view prior to assembly. FIG. 17B schematically depicts the second portion from a bottom view. FIG. 17C schematically depicts the first portion from a top view. FIG. 17D schematically depicts assembled first and second portions from a side view.

FIG. 18 schematically shows a head portion of a tooth brushing device from partially transparent top view according to one embodiment of the invention.

FIGS. 19A-J schematically illustrate tooth brushing devices or components thereof from various views according to certain embodiments of the invention. FIGS. 19A-C schematically show a rotational component from bottom, top, and side views, respectively. FIGS. 19D and E schematically show rotational components and drive mechanism components or portions thereof from bottom and top views according to one embodiment of the invention. FIG. 19F schematically illustrates the rotational components and drive mechanism components or portions thereof from FIG. 19E operably connected to motor and power source components from a side view. FIG. 19G schematically depict rotational components operably connected to drive mechanism components from a side view according to one embodiment of the invention. FIG. 19H schematically shows a tooth brushing device that includes the rotational components and drive mechanism components from FIG. 19F from a partially transparent side view according to one embodiment of the invention. FIGS. 19 I and J schematically show the tooth brushing device of FIG. 19H from side and top views, respectively.

FIG. 20 schematically illustrates rotational components having resilient couplings and drive mechanism components or portions thereof operably connected to motor and power source components from a side view according to one embodiment of the invention.

FIG. 21 schematically illustrates rotational components having resilient couplings and drive mechanism components or portions thereof operably connected to motor and power source components from a side view according to one embodiment of the invention.

FIG. 22 schematically shows a handheld device that includes rotational components having resilient couplings from a side view according to one embodiment of the invention.

FIG. 23A schematically shows a handheld device that includes second portions of rotational components from a side view prior to assembly according to one embodiment of the invention. FIG. 23B schematically shows the handheld device from FIG. 23A following assembly.

FIG. 24A schematically shows a handheld device that includes second portions of rotational components from a side view prior to assembly according to one embodiment of the invention. FIG. 24B schematically shows the handheld device from FIG. 24A following assembly.

FIG. 25A schematically shows a handheld device that includes second portions of rotational components from a side view prior to assembly according to one embodiment of the invention. FIG. 25B schematically shows the handheld device from FIG. 25A following assembly.

FIG. 26A schematically shows a handheld device that includes second portions of rotational components from a side view prior to assembly according to one embodiment of the invention. FIG. 26B schematically shows the handheld device from FIG. 88A following assembly.

FIGS. 27A-G schematically illustrate a handheld device, or portions thereof, that includes a positioning mechanism from various views according to one exemplary embodiment of the invention. FIG. 27A schematically depicts drive mechanism components or portions thereof (with a positioning mechanism) operably connected to motor and power source components from a side view. FIG. 27B schematically depicts the handheld device from FIG. 27A with a housing component from a partial sectional side view. FIG. 27C schematically depicts the handheld device from FIG. 27A with a housing component from a side view. FIG. 27D schematically depicts the drive mechanism components or portions thereof from FIG. 27A operably connected to motor and power source components from a side view. FIG. 27E schematically depicts the handheld device from FIG. 27A with a housing component from a partial sectional side view. FIG. 27F schematically depicts the handheld device from FIG. 27A with a housing component from a side view. FIG. 27G schematically depicts the positioning mechanism of the handheld device from FIG. 27A from a broken view.

FIGS. 28A-F schematically illustrate a handheld device, or portions thereof, that includes a positioning mechanism from various views according to one exemplary embodiment of the invention. FIG. 28A schematically depicts drive mechanism components or portions thereof (with a positioning mechanism) operably connected to motor and power source components from a side view. FIG. 28B schematically depicts the handheld device from FIG. 28A with a housing component from a partial sectional side view. FIG. 28C schematically depicts the handheld device from FIG. 28A with a housing component from a side view. FIG. 28D schematically depicts the drive mechanism components or portions thereof from FIG. 28A operably connected to motor and power source components from a side view. FIG. 28E schematically depicts the handheld device from FIG. 28A with a housing component from a partial sectional side view. FIG. 28F schematically depicts the handheld device from FIG. 28A with a housing component from a side view.

FIGS. 29A-F schematically illustrate a handheld device, or portions thereof, that includes positioning mechanisms from various views according to one exemplary embodiment of the invention. FIG. 29A schematically depicts drive mechanism components or portions thereof (with positioning mechanisms) operably connected to motor and power source components from a side view. FIG. 29B schematically depicts the handheld device from FIG. 29A with a housing component from a partial sectional side view. FIG. 29C schematically depicts the handheld device from FIG. 29A with a housing component from a side view. FIG. 29D schematically depicts the drive mechanism components or portions thereof from FIG. 29A operably connected to motor and power source components from a side view. FIG. 29E schematically depicts the handheld device from FIG. 29A with a housing component from a partial sectional side view. FIG. 29F schematically depicts the handheld device from FIG. 29A with a housing component from a side view.

### DETAILED DESCRIPTION

### I. Introduction

Before describing the invention in detail, it is to be understood that this invention is not limited to particular methods, rotary units, rotary mechanisms, devices, or systems, which can vary. As used in this specification and the appended claims, the singular forms “a,” “an,” and “the” also include plural referents unless the context clearly provides otherwise. It is also to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which this invention pertains. In describing and claiming the invention, the following terminology, and grammatical variants thereof, will be used in accordance with the definitions set forth below.

The term “coaxially positioned” refers to objects that are positioned relative to one another such that they can rotate about a substantially coincident axis.

The term “fixed position” refers to objects that are positioned relative to one another such that they do not move separately from one another. In some embodiments, for example, gear components (e.g., sun gear components) are attached (e.g., integrally fabricated, bonded, welded, adhered, or the like) to rotational components, such that when the rotational components move in one direction, the gear components move in the same direction as the rotational components.

The term “counter-rotate” or “contra-rotate” refers to objects that rotate in opposite directions relative to one another. In some embodiments, for example, rotary mechanisms include rotational components that are configured to rotate in opposite directions.

The term “communicate” refers to the direct or indirect transfer or transmission, and/or capability of directly or indirectly transferring or transmitting, something at least from one thing to another thing. In some embodiments, for example, devices include housings having openings through which hair, finger nails, or the like can be transferred to contact implements within housing cavities of the devices.

The invention relates to rotary units and rotary mechanisms that are suitable for use in numerous applications. Rotary units typically include rotational components that are configured to rotate. In some embodiments, for example, multiple rotary units are assembled in rotary mechanisms such that neighboring pairs of rotational components counter-rotate or contra-rotate relative to one another during operation of the rotary mechanisms. Rotational components generally include one or more implements that are structured to perform or effect one or more types of work as the rotational components rotate relative to one another in a given rotary mechanism. In certain embodiments, implements are configured to rotate and/or to effect the movement of other components as rotational components rotate. The representative embodiments described herein are intended to illustrate, but not to limit, the invention. Essentially any combination of components or portions thereof described herein are optionally utilized or adapted for use together in certain embodiments.

### II. Exemplary Rotary Units

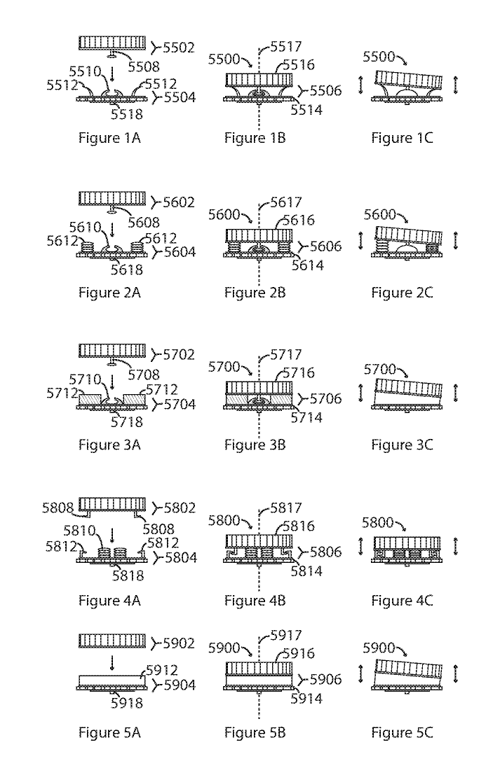

FIGS. 1A-C schematically illustrate a rotational component, or portions thereof, that include at least one resilient coupling from side views according to one exemplary embodiment of the invention. FIGS. 1 A and B are shown from partial sectional side views. As shown, rotational component 5500 includes first portion 5502 and second portion 5504. Rotational component 5500 also includes resilient coupling 5506, which resiliently couples first portion 5502 and second portion 5504 to one another. Resilient coupling 5506 includes a positioning mechanism (post 5508 and post retainer 5510) that positions the first and second portions relative to one another within a range of motion (see, e.g., directional arrows in FIG. 1C). Resilient coupling 5506 also includes flexible prongs 5512, which resiliently position first portion 5502 relative to second portion 5504. Rotational component 5500 also includes gear component 5514 that is configured to mesh with one or more gear components of neighboring rotational components and/or drive mechanism components. In the embodiment shown, rotational component 5500 includes implements 5516 (shown as bristles) disposed on a surface that is configured to rotate substantially perpendicular to rotational axis 5517 of rotational component 5500. Exemplary implements and rotary mechanisms that are optionally adapted for use with rotational components are described herein. Rotational component 5500 also includes alignment component 5518 (shown as a peg in this embodiment) that align rotational component 5500 relative, e.g., to a housing or other component.

FIGS. 2A-C schematically illustrate a rotational component, or portions thereof, that include at least one resilient coupling from side views according to one exemplary embodiment of the invention. FIGS. 2 A and B are shown from partial sectional side views. As shown, rotational component 5600 includes first portion 5602 and second portion 5604. Rotational component 5600 also includes resilient coupling 5606, which resiliently couples first portion 5602 and second portion 5604 to one another. Resilient coupling 5606 includes a positioning mechanism (post 5608 and post retainer 5610) that positions the first and second portions relative to one another within a range of motion (see, e.g., directional arrows in FIG. 2C). Resilient coupling 5606 also includes spring mechanisms 5612, which resiliently position first portion 5602 relative to second portion 5604. Rotational component 5600 also includes gear component 5614 that is configured to mesh with one or more gear components of neighboring rotational components and/or drive mechanism components. In the embodiment shown, rotational component 5600 includes implements 5616 (shown as bristles) disposed on a surface that is configured to rotate substantially perpendicular to rotational axis 5617 of rotational component 5600. Exemplary implements and rotary mechanisms that are optionally adapted for use with rotational components are described herein. Rotational component 5600 also includes alignment component 5618 (shown as a peg in this embodiment) that align rotational component 5600 relative, e.g., to a housing or other component.

FIGS. 3A-C schematically illustrate a rotational component, or portions thereof, that include at least one resilient coupling from side views according to one exemplary embodiment of the invention. FIGS. 3 A and B are shown from partial sectional side views. As shown, rotational component 5700 includes first portion 5702 and second portion 5704. Rotational component 5700 also includes resilient coupling 5706, which resiliently couples first portion 5702 and second portion 5704 to one another. Resilient coupling 5706 includes a positioning mechanism (post 5708 and post retainer 5710) that positions the first and second portions relative to one another within a range of motion (see, e.g., directional arrows in FIG. 3C). Resilient coupling 5706 also includes flexible or elastomeric material 5712, which resiliently positions first portion 5702 relative to second portion 5704. Rotational component 5700 also includes gear component 5714 that is configured to mesh with one or more gear components of neighboring rotational components and/or drive mechanism components. In the embodiment shown, rotational component 5700 includes implements 5716 (shown as bristles) disposed on a surface that is configured to rotate substantially perpendicular to rotational axis 5717 of rotational component 5700. Exemplary implements and rotary mechanisms that are optionally adapted for use with rotational components are described herein. Rotational component 5700 also includes alignment component 5718 (shown as a peg in this embodiment) that align rotational component 5700 relative, e.g., to a housing or other component.

FIGS. 4A-C schematically illustrate a rotational component, or portions thereof, that include at least one resilient coupling from side views according to one exemplary embodiment of the invention. As shown, rotational component 5800 includes first portion 5802 and second portion 5804. Rotational component 5800 also includes resilient coupling 5806, which resiliently couples first portion 5802 and second portion 5804 to one another. Resilient coupling 5806 includes a positioning mechanism (shown as interlocking retainer components 5808 and 5812) that positions the first and second portions relative to one another within a range of motion (see, e.g., directional arrows in FIG. 4C). Resilient coupling 5806 also includes spring mechanisms 5810, which resiliently position first portion 5802 relative to second portion 5804. Rotational component 5800 also includes gear component 5814 that is configured to mesh with one or more gear components of neighboring rotational components and/or drive mechanism components. In the embodiment shown, rotational component 5800 includes implements 5816 (shown as bristles) disposed on a surface that is configured to rotate substantially perpendicular to rotational axis 5817 of rotational component 5800. Exemplary implements and rotary mechanisms that are optionally adapted for use with rotational components are described herein. Rotational component 5800 also includes alignment component 5818 (shown as a peg in this embodiment) that align rotational component 5800 relative, e.g., to a housing or other component.

FIGS. 5A-C schematically illustrate a rotational component, or portions thereof, that include at least one resilient coupling from side views according to one exemplary embodiment of the invention. As shown, rotational component 5900 includes first portion 5902 and second portion 5904. Rotational component 5900 also includes resilient coupling 5906, which resiliently couples first portion 5902 and second portion 5904 to one another. Resilient coupling 5906 includes material container component 5912 (e.g., a flexible bladder or the like that is at least partially filled with a fluidic (e.g., a gas, a liquid, etc.) and/or semi-fluidic (e.g., a gel, etc.) material) that resiliently positions the first and second portions relative to one another (see, e.g., directional arrows in FIG. 5C). Rotational component 5900 also includes gear component 5914 that is configured to mesh with one or more gear components of neighboring rotational components and/or drive mechanism components. In the embodiment shown, rotational component 5900 includes implements 5916 (shown as bristles) disposed on a surface that is configured to rotate substantially perpendicular to rotational axis 5917 of rotational component 5900. Exemplary implements and rotary mechanisms that are optionally adapted for use with rotational components are described herein. Rotational component 5900 also includes alignment component 5918 (shown as a peg in this embodiment) that align rotational component 5900 relative, e.g., to a housing or other component.

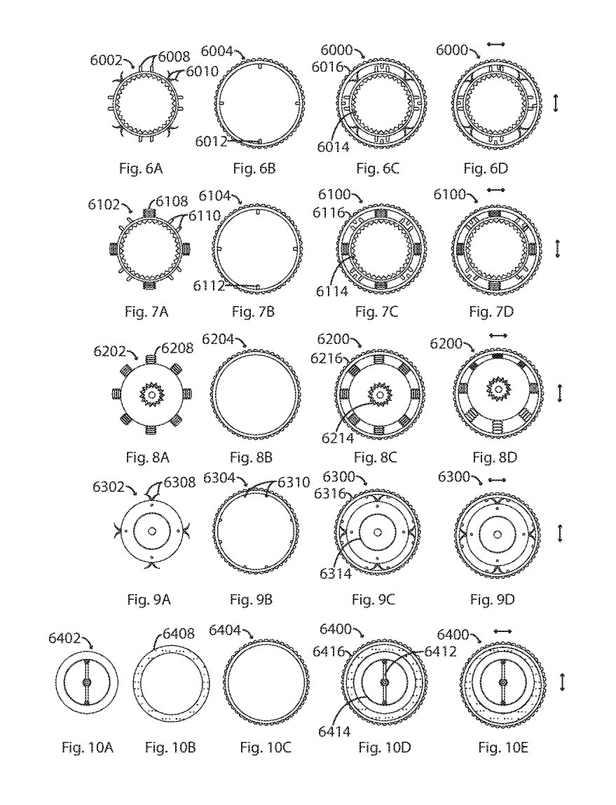

FIGS. 6A-D schematically illustrate a rotational component, or portions thereof, that include at least one resilient coupling from side views according to one exemplary embodiment of the invention. As shown, rotational component 6000 includes first portion 6002 and second portion 6004. FIGS. 6 A and B schematically depict first portion 6002 and second portion 6004 prior to assembly of rotational component 6000, while FIGS. 6 C and D schematically illustrate first portion 6002 and second portion 6004 following the assembly of rotational component 6000. Rotational component 6000 also includes a resilient coupling that resiliently couples first portion 6002 and second portion 6004 to one another. The resilient coupling includes a positioning mechanism (shown as retainer components 6008 and 6012) that positions the first and second portions relative to one another within a range of motion (see, e.g., directional arrows in FIG. 60D). The resilient coupling also includes flexible prongs 6010, which resiliently position first portion 6002 relative to second portion 6004. Rotational component 6000 also includes gear component 6014 that is configured to mesh with, e.g., one or more other gear components of rotational component 6000, one or more gear components of other rotational components and/or one or more gear components of drive mechanism components. In the embodiment shown, rotational component 6000 includes implements 6016 disposed on a surface that is configured to rotate substantially parallel to a rotational axis of rotational component 6000. Exemplary implements and rotary mechanisms that are optionally adapted for use with rotational components are described herein.

FIGS. 7A-D schematically illustrate a rotational component, or portions thereof, that include at least one resilient coupling from side views according to one exemplary embodiment of the invention. As shown, rotational component 6100 includes first portion 6102 and second portion 6104. FIGS. 7 A and B schematically depict first portion 6102 and second portion 6104 prior to assembly of rotational component 6100, while FIGS. 7 C and D schematically illustrate first portion 6102 and second portion 6104 following the assembly of rotational component 6100. Rotational component 6100 also includes a resilient coupling that resiliently couples first portion 6102 and second portion 6104 to one another. The resilient coupling includes a positioning mechanism (shown as retainer components 6110 and 6112) that positions the first and second portions relative to one another within a range of motion (see, e.g., directional arrows in FIG. 7D). The resilient coupling also includes spring mechanisms 6108, which resiliently position first portion 6102 relative to second portion 6104. Rotational component 6100 also includes gear component 6114 that is configured to mesh with, e.g., one or more other gear components of rotational component 6100, one or more gear components of other rotational components and/or one or more gear components of drive mechanism components. In the embodiment shown, rotational component 6100 includes implements 6116 disposed on a surface that is configured to rotate substantially parallel to a rotational axis of rotational component 6100. Exemplary implements and rotary mechanisms that are optionally adapted for use with rotational components are described herein.

FIGS. 8A-D schematically illustrate a rotational component, or portions thereof, that include at least one resilient coupling from side views according to one exemplary embodiment of the invention. As shown, rotational component 6200 includes first portion 6202 and second portion 6204. FIGS. 8 A and B schematically depict first portion 6202 and second portion 6204 prior to assembly of rotational component 6200, while FIGS. 8 C and D schematically illustrate first portion 6202 and second portion 6204 following the assembly of rotational component 6200. Rotational component 6200 also includes a resilient coupling that resiliently couples first portion 6202 and second portion 6204 to one another. The resilient coupling includes spring mechanisms 6208, which resiliently position first portion 6202 relative to second portion 6204 within a range of motion (see, e.g., directional arrows in FIG. 8D). Rotational component 6200 also includes gear component 6214 that is configured to mesh with, e.g., one or more gear components of other rotational components and/or drive mechanism components. In the embodiment shown, rotational component 6200 includes implements 6216 disposed on a surface that is configured to rotate substantially parallel to a rotational axis of rotational component 6200. Exemplary implements and rotary mechanisms that are optionally adapted for use with rotational components are described herein.

FIGS. 9A-D schematically illustrate a rotational component, or portions thereof, that include at least one resilient coupling from side views according to one exemplary embodiment of the invention. As shown, rotational component 6300 includes first portion 6302 and second portion 6304. FIGS. 9 A and B schematically depict first portion 6302 and second portion 6304 prior to assembly of rotational component 6300, while FIGS. 9 C and D schematically illustrate first portion 6302 and second portion 6304 following the assembly of rotational component 6300. Rotational component 6300 also includes a resilient coupling that resiliently couples first portion 6302 and second portion 6304 to one another. The resilient coupling includes a positioning mechanism (shown as retainer components 6310 and flexible prongs 6308) that resiliently position the first and second portions relative to one another within a range of motion (see, e.g., directional arrows in FIG. 9D). Rotational component 6300 also includes gear component 6314 that is configured to mesh with, e.g., one or more gear components of other rotational components and/or drive mechanism components. In the embodiment shown, rotational component 6300 includes implements 6316 disposed on a surface that is configured to rotate substantially parallel to a rotational axis of rotational component 6300. Exemplary implements and rotary mechanisms that are optionally adapted for use with rotational components are described herein.

FIGS. 10A-E schematically illustrate a rotational component, or portions thereof, that include at least one resilient coupling from side views according to one exemplary embodiment of the invention. As shown, rotational component 6400 includes first portion 6402 and second portion 6404. Rotational component 6400 also includes a resilient coupling, which resiliently couples first portion 6402 and second portion 6404 to one another. The resilient coupling includes material container component 6408 (e.g., a flexible bladder or the like that is at least partially filled with a fluidic (e.g., a gas, a liquid, etc.) and/or semi-fluidic (e.g., a gel, etc.) material) that resiliently positions the first and second portions relative to one another (see, e.g., directional arrows in FIG. 10E). FIGS. 10 A-C schematically depict first portion 6402, material container component 6408, and second portion 6404, respectively, prior to assembly of rotational component 6400, while FIGS. 10 D and E schematically illustrate first portion 6402, material container component 6408, and second portion 6404 following the assembly of rotational component 6400. Rotational component 6400 also includes gear component 6414 that is configured to mesh with, e.g., gear structure 6412 and/or drive mechanism components. In the embodiment shown, rotational component 6400 includes implements 6416 disposed on a surface that is configured to rotate substantially parallel to a rotational axis of rotational component 6400. Exemplary implements and rotary mechanisms that are optionally adapted for use with rotational components are described herein.

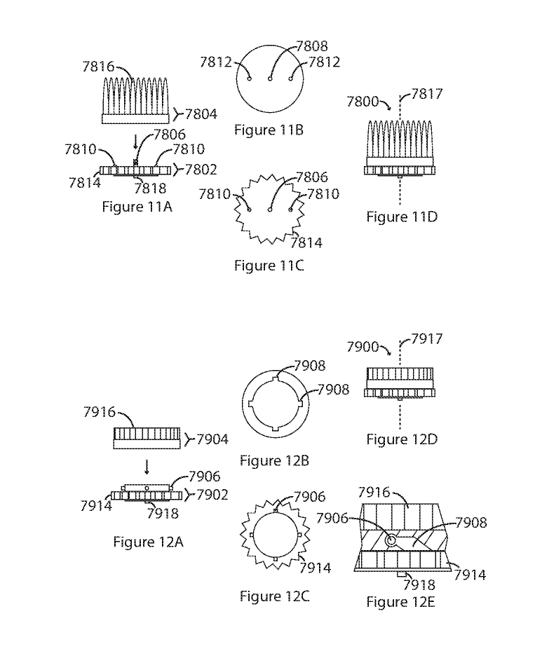

FIGS. 11A-D schematically illustrate a rotary unit with rotational component 7800, or portions thereof, that includes first portion 7802 and second portion 7804 with attachment components (external threaded component 7806 and internal threaded component 7808) from various views according to one exemplary embodiment of the invention. Internal threaded component 7808 is configured to receive external threaded component 7806 to reversibly attach first portion 7802 and second portion 7804 to one another. As also shown, rotational component 7800 also includes a retaining mechanism (protrusions 7810 and protrusion receiving areas 7812). Protrusion receiving areas 7812 are configured to receive protrusions 7810 to retain second portion 7804 in position relative to first portion 7802 when second portion 7804 is reversibly attached to first portion 7802. Rotational component 7800 also includes gear component 7814 that is configured to mesh with one or more gear components of neighboring rotational components and/or drive mechanism components. In the embodiment shown, rotational component 7800 includes implements 7816 (shown as bristles) disposed on a surface that is configured to rotate substantially perpendicular to rotational axis 7817 of rotational component 7800. Exemplary implements and rotary mechanisms that are optionally adapted for use with rotational components are described herein. Rotational component 7800 also includes alignment component 7818 (shown as a peg in this embodiment) that align rotational component 7800 relative, e.g., to a housing or other component.

FIGS. 12A-E schematically illustrate rotational component 7900, or portions thereof, that includes first portion 7902 and second portion 7904 with attachment components (shown as compression mechanism components (protrusions 7906 and protrusion receiving areas 7908)) from various views according to one exemplary embodiment of the invention. Protrusion receiving areas 7908 are configured to receive protrusions 7906 to reversibly attach first portion 7902 and second portion 7904 to one another. Protrusion receiving areas 7908 exert compressive forces on protrusions 7906 when protrusion receiving areas 7908 receive protrusions 7906 to retain and reversibly attach first portion 7902 and second portion 7904 together. Rotational component 7900 also includes gear component 7914 that is configured to mesh with one or more gear components of neighboring rotational components and/or drive mechanism components. In the embodiment shown, rotational component 7900 includes implements 7916 (shown as bristles) disposed on a surface that is configured to rotate substantially perpendicular to rotational axis 7917 of rotational component 7900. Exemplary implements and rotary mechanisms that are optionally adapted for use with rotational components are described herein. Rotational component 7900 also includes alignment component 7918 (shown as a peg in this embodiment) that align rotational component 7900 relative, e.g., to a housing or other component.

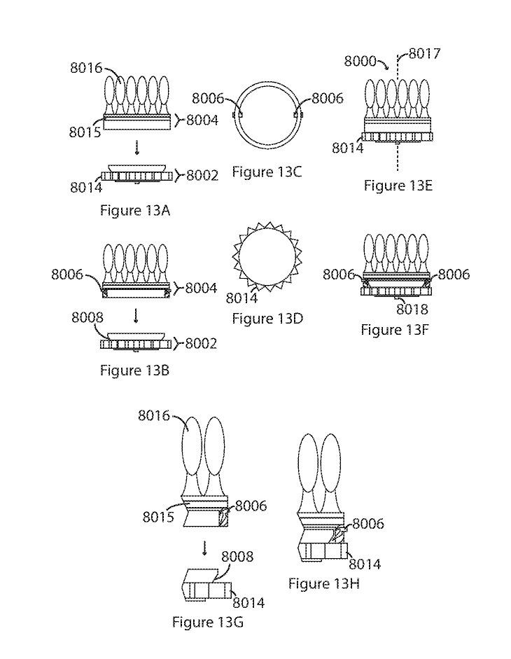

FIGS. 13A-H schematically illustrate rotational component 8000, or portions thereof, that includes first portion 8002 and second portion 8004 with attachment components (shown as latch components (latches 8006 and keepers 8008)) from various views according to one exemplary embodiment of the invention. Keepers 8008 are configured to receive latches 8006 to reversibly attach first portion 8002 and second portion 8004 to one another. As also shown, rotational component 8000 also includes resilient coupling 8015, which resiliently couples segments of second portion 8004 to one another. In other exemplary embodiments, segments of first portions are resiliently coupled together. In some embodiments, first and second portions are resiliently coupled to one another. Additional examples of resilient couplings that are optionally adapted for use with rotational components are described further herein and, for example, in U.S. Patent Application Publication No. US 2014/0323263, entitled “ROTARY UNITS, ROTARY MECHANISMS, AND RELATED APPLICATIONS” filed Jul. 9, 2014 by Sappenfield, which is incorporated by reference in its entirety. Rotational component 8000 also includes gear component 8014 that is configured to mesh with one or more gear components of neighboring rotational components and/or drive mechanism components. In the embodiment shown, rotational component 8000 includes implements 8016 (shown as bristles (e.g., fabricated from silicone, thermoplastic elastomers (TPE), and/or the like)) disposed on a surface that is configured to rotate substantially perpendicular to rotational axis 8017 of rotational component 8000. Exemplary implements and rotary mechanisms that are optionally adapted for use with rotational components are described herein. Rotational component 8000 also includes alignment component 8018 (shown as a peg in this embodiment) that align rotational component 8000 relative, e.g., to a housing or other component.

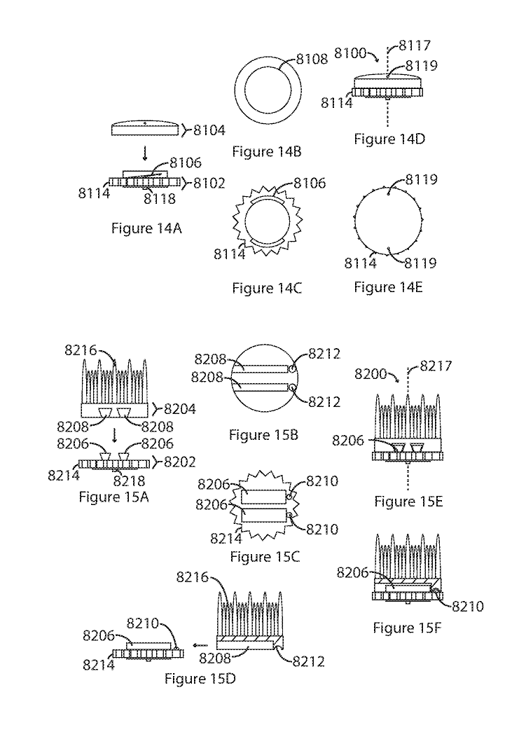

FIGS. 14A-E schematically illustrate rotational component 8100, or portions thereof, that includes first portion 8102 and second portion 8104 with attachment components (external threaded component 8106 and internal threaded component 8108) from various views according to one exemplary embodiment of the invention. Internal threaded component 8108 is configured to receive external threaded component 8106 to reversibly attach first portion 8102 and second portion 8104 to one another. Rotational component 8100 also includes gear component 8114 that is configured to mesh with one or more gear components of neighboring rotational components and/or drive mechanism components. In the embodiment shown, second portion 8104 lacks implements (shown as a blank) disposed on a surface that is configured to rotate substantially perpendicular to rotational axis 8117 of rotational component 8100. As also shown, second portion 8104 includes recess features 8119 that can be used to assist (e.g., using separate tool or the like) with the attachment and detachment of second portion 8104 to or from first portion 8102. Rotational component 8100 also includes alignment component 8118 (shown as a peg in this embodiment) that align rotational component 8100 relative, e.g., to a housing or other component.

FIGS. 15A-F schematically illustrate rotational component 8200, or portions thereof, that includes first portion 8202 and second portion 8204 with attachment components (shown as tapered projections 8206 (e.g., tenons, dovetail joint components, etc.) and recess components 8208 (e.g., mortises, dovetail joint components, etc.)) from various views according to one exemplary embodiment of the invention. As also shown, rotational component 8200 also includes a retaining mechanism (protrusions 8210 and protrusion receiving areas 8212). Protrusion receiving areas 8212 are configured to receive protrusions 8210 to retain second portion 8204 in position relative to first portion 8202 when second portion 8204 is reversibly attached to first portion 8202. Rotational component 8200 also includes gear component 8214 that is configured to mesh with one or more gear components of neighboring rotational components and/or drive mechanism components. In the embodiment shown, rotational component 8200 includes implements 8216 (shown as bristles) disposed on a surface that is configured to rotate substantially perpendicular to rotational axis 8217 of rotational component 8200. Exemplary implements and rotary mechanisms that are optionally adapted for use with rotational components are described herein. Rotational component 8200 also includes alignment component 8218 (shown as a peg in this embodiment) that align rotational component 8200 relative, e.g., to a housing or other component.

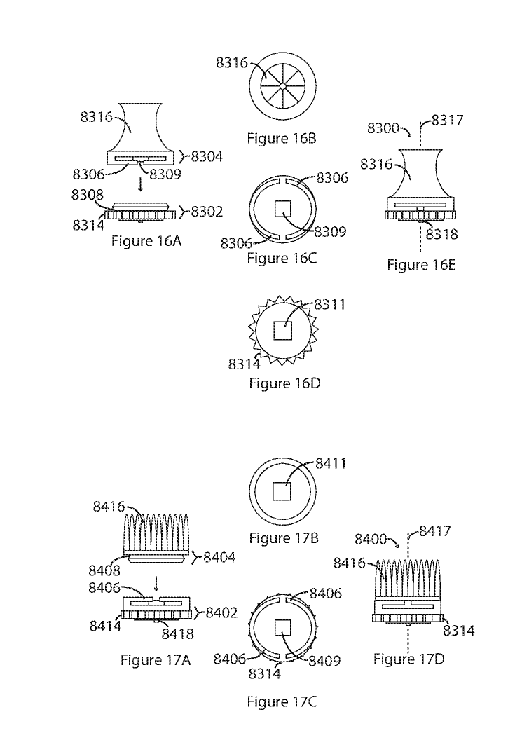

FIGS. 16A-E schematically illustrate rotational component 8300, or portions thereof, that includes first portion 8302 and second portion 8304 with attachment components (shown as compression mechanism components (flexible protrusions 8306 and protrusion receiving areas 8308)) from various views according to one exemplary embodiment of the invention. Protrusion receiving areas 8308 are configured to receive protrusions 8306 to reversibly attach first portion 8302 and second portion 8304 to one another. Protrusions 8306 exert compressive forces on protrusion receiving area 8308 when protrusion receiving areas 8308 receive protrusions 8306 to retain and reversibly attach first portion 8302 and second portion 8304 together. Rotational component 8300 also includes alignment protrusion 8309 and alignment protrusion receiving area 8311, which is configured to receive alignment protrusion 8309 to align second portion 8304 relative to first portion 8302. Rotational component 8300 also includes gear component 8314 that is configured to mesh with one or more gear components of neighboring rotational components and/or drive mechanism components. In the embodiment shown, rotational component 8300 includes implement 8316 (shown as a polishing cup) disposed on a surface that is configured to rotate substantially perpendicular to rotational axis 8317 of rotational component 8300. Exemplary implements and rotary mechanisms that are optionally adapted for use with rotational components are described herein. Rotational component 8300 also includes alignment component 8318 (shown as a peg in this embodiment) that align rotational component 8300 relative, e.g., to a housing or other component.

FIGS. 17A-D schematically illustrate a rotational component 8400, or portions thereof, that includes first portion 8402 and second portion 8404 with attachment components (shown as compression mechanism components (flexible protrusions 8406 and protrusion receiving areas 8408)) from various views according to one exemplary embodiment of the invention. Protrusion receiving areas 8408 are configured to receive protrusions 8406 to reversibly attach first portion 8402 and second portion 8404 to one another. Protrusions 8406 exert compressive forces on protrusion receiving area 8408 when protrusion receiving areas 8408 receive protrusions 8406 to retain and reversibly attach first portion 8402 and second portion 8404 together. Rotational component 8400 also includes alignment protrusion 8409 and alignment protrusion receiving area 8411, which is configured to receive alignment protrusion 8409 to align second portion 8404 relative to first portion 8402. Rotational component 8400 also includes gear component 8414 that is configured to mesh with one or more gear components of neighboring rotational components and/or drive mechanism components. In the embodiment shown, rotational component 8400 includes implement 8416 (shown as bristles) disposed on a surface that is configured to rotate substantially perpendicular to rotational axis 8417 of rotational component 8400. Exemplary implements and rotary mechanisms that are optionally adapted for use with rotational components are described herein. Rotational component 8400 also includes alignment component 8418 (shown as a peg in this embodiment) that align rotational component 8400 relative, e.g., to a housing or other component.

### III. Exemplary Rotary Mechanisms and Applications

In certain embodiments, the invention provides rotary or rotational mechanisms that include two or more rotational components or rotary units (e.g., 2, 3, 4, 5, 6, 7, 8, 9, 10, 11, 12, 13, 14, 15, or more rotational components or rotary units). Rotary mechanisms also typically include at least one counter-rotational mechanism operably coupled to one or more of the rotational components. The counter-rotational mechanism is generally configured to effect substantially simultaneous counter-rotation of the rotational components relative to one another when movement of at least a portion of the counter-rotational mechanism is effected. Rotary mechanisms also typically include drive mechanisms operably coupled to the counter-rotational mechanism and/or rotational components. Drive mechanisms are typically configured to effect movement of at least the portion of the counter-rotational mechanisms such that the rotational components substantially simultaneously counter-rotate relative to one another. In some embodiments, for example, multiple rotary units are included as components (e.g., rotational components and counter-rotational mechanisms, etc.) of rotary mechanisms.

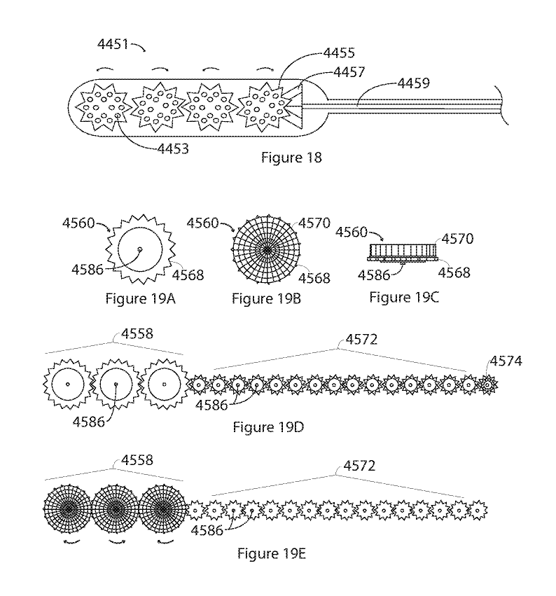

FIG. 18 schematically shows a head portion of a tooth brushing device from partially transparent top view according to one embodiment of the invention. As shown, head portion 4451 includes rotational components 4455 that include gear components that mesh with one another. Rotational components 4455 also have surfaces that are configured to rotate substantially perpendicular to rotational axes of rotational components 4455. These surfaces include implements 4453. One rotational component 4455 also meshes with gear component 4457. Gear component 4457 is operably connected to shaft component 4459, which is typically operably connected to a motor or the like (e.g., disposed in a handle portion of the tooth brushing device (not within view)) that is configured to effect rotation of shaft component 4459 and gear component 4457 (e.g., in one or both directions, in an oscillating mode, etc.). As gear component 4457 rotates, it effects the counter-rotation of rotational components 4455.

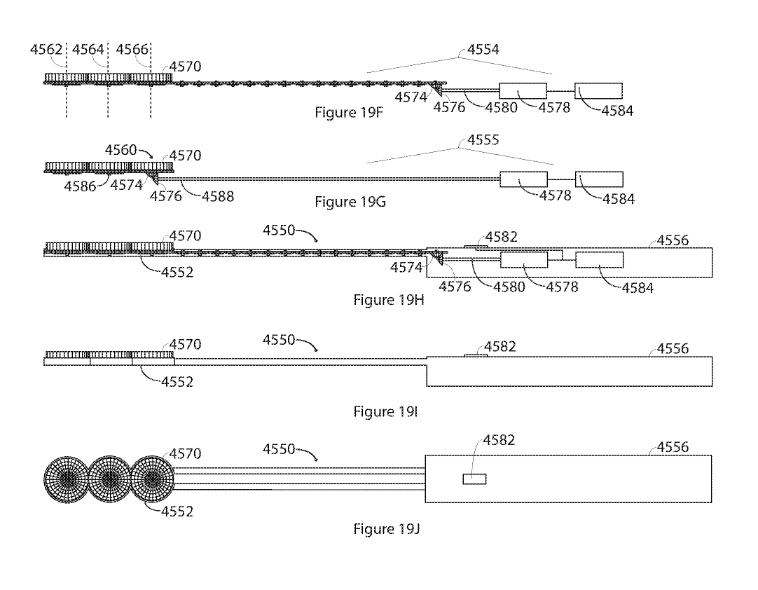

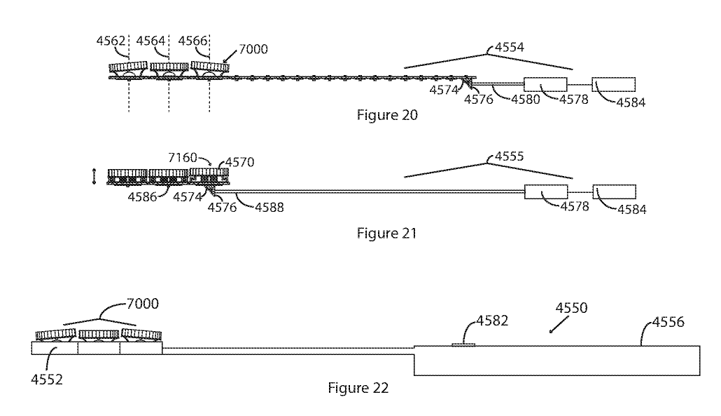

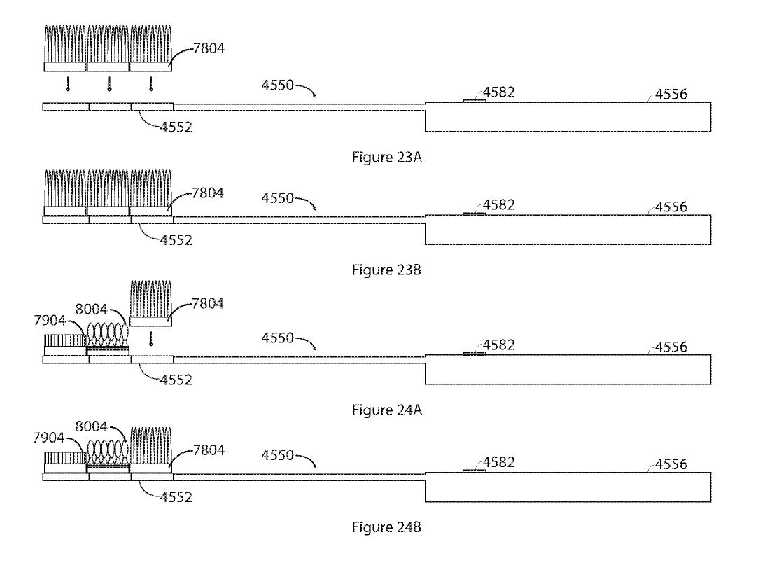

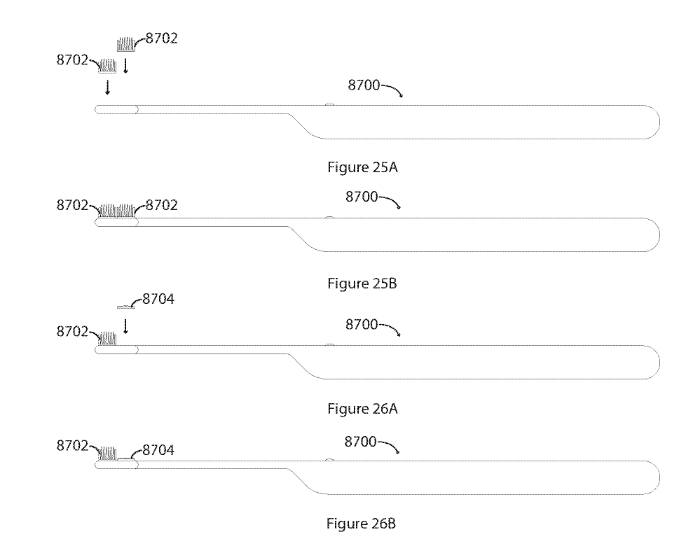

FIGS. 19A-J schematically illustrate handheld devices (e.g., tooth brushing devices) or components thereof from various views according to certain embodiments of the invention. As shown, handheld device 4550 includes head portion 4552, drive mechanism component 4554, and handle portion 4556. In the embodiment shown, head portion 4552 and handle portion 4556 are fabricated integral with one another (i.e., non-detachable from one another). In other embodiments, head and handle portions (and drive mechanism components or portions thereof) are detachable from one another. Head portion 4552 includes rotary mechanism 4558, which includes three rotational components 4560 in this exemplary embodiment. Rotational components 4560 are configured to rotate at least partially around rotational axis 4562, 4564, or 4566. Rotational components 4560 include gear components 4568 that are configured to mesh with one or more gear components of neighboring rotational components and/or drive mechanism components. In the embodiment shown, each rotational component 4560 includes implements 4570 disposed on a surface that is configured to rotate substantially perpendicular to a rotational axis (e.g., rotational axis 4562, 4564, or 4566) of the rotational component 4560. In some embodiments, rotational components 4560 are selectively interchangeable with other rotational components (e.g., having the same or different implement configurations). FIG. 20 schematically illustrates rotational components 7000 having resilient couplings and drive mechanism components or portions thereof operably connected to motor and power source components from a side view according to one embodiment of the invention. FIG. 21 schematically illustrates rotational components 7160 having resilient couplings and drive mechanism components or portions thereof operably connected to motor and power source components from a side view according to one embodiment of the invention. FIG. 22 schematically shows a handheld device that includes rotational components 7000 having resilient couplings from a side view according to one embodiment of the invention. FIG. 23A schematically shows a handheld device that includes selectively interchangeable second portions 7804 of rotational components 7800 from a side view prior to assembly according to one embodiment of the invention. FIG. 23B schematically shows the handheld device from FIG. 23A following assembly. FIG. 24A schematically shows a handheld device that includes selectively interchangeable second portions (7804, 7904, and 8004) of rotational components from a side view prior to assembly according to one embodiment of the invention. FIG. 24B schematically shows the handheld device from FIG. 86A following assembly. FIG. 25A schematically shows handheld device 8700 that includes selectively interchangeable second portions 8702 of rotational components from a side view prior to assembly according to one embodiment of the invention. As shown, handheld device 8700 includes two rotational components. Handheld device 8700 is otherwise configured similar to handheld device 4550. FIG. 25B schematically shows handheld device 8700 following assembly. FIG. 26A schematically shows handheld device 8700 that includes selectively interchangeable second portions 8702 and 8704 of rotational components from a side view prior to assembly according to one embodiment of the invention. FIG. 26B schematically shows handheld device 8700 following assembly. Second portion 8704 is shown as a blank similar to second portion 8104 of rotational component 8100 as described herein. In some embodiments, for example, second portions comprise snap-on prophy cups, snap-on bristle heads, latch-type prophy cups, latch-type bristle heads, screw-on prophy cups, screw-on bristle heads, and the like. Exemplary prophy cups, bristles heads, and the like that are optionally adapted for use with the handheld devices described herein are further described, for example, in Phinney et al., Dental Assisting: A Comprehensive Approach, Cengage Learning, 4th Ed. (2012), Gladwin et al., Clinical Aspects of Dental Materials, LWW, 4th Ed. (2012), and Mosby, Mosby's Dental Dictionary, Mosby 3^{rd} Ed. (2013), which are each incorporated by reference.

Drive mechanism component 4554 includes a chain of meshed gear components 4572 that mesh with gear component 4568 of one rotational component 4560 and extend from head portion 4552 to handle portion 4556. As shown, one gear component 4572 includes gear 4574 that meshes with gear 4576. Gear 4576 is operably connected to motor component 4578 via shaft component 4580. Motor component 4578 is also operably connected to switch component 4582 (e.g., an on/off switch, etc.) and power source component 4584 (e.g., a rechargeable battery, etc.). During operation, motor component 4578 effects rotation of shaft component 4580, gears 4574 and 4576, and gear components 4572 such that neighboring pairs of rotational components 4560 rotate at least partially or completely (e.g., 360° or more) around rotational axis 4562, 4564, or 4566 in directions (see, directional arrows shown, for example, in FIG. 19E) that are substantially opposite one another. Rotary mechanism 4558 and drive mechanism component 4554 are at least partially disposed within a housing. Rotational components 4560 and gear components 4572 include alignment components 4586 (shown as pegs in this embodiment) that align rotational components 4560 and gear components 4572 relative to the housing (e.g., via corresponding seatings (not within view)).

Other drive mechanism components are also optionally used with rotational components 4560. As shown in FIG. 19G, for example, drive mechanism component 4555 includes shaft component 4588 instead of chain of meshed gear components 4572. As shown, one rotational component 4560 includes gear 4574 that meshes with gear 4576. Gear 4576 is operably connected to motor component 4578 via shaft component 4588. Motor component 4578 is also operably connected to power source component 4584 (e.g., a rechargeable battery, etc.). During operation, motor component 4578 effects rotation of shaft component 4588, gears 4574 and 4576, and gear components 4568 such that neighboring pairs of rotational components 4560 rotate at least partially or completely (e.g., 360° or more) around rotational axis 4562, 4564, or 4566 in directions that are substantially opposite one another.

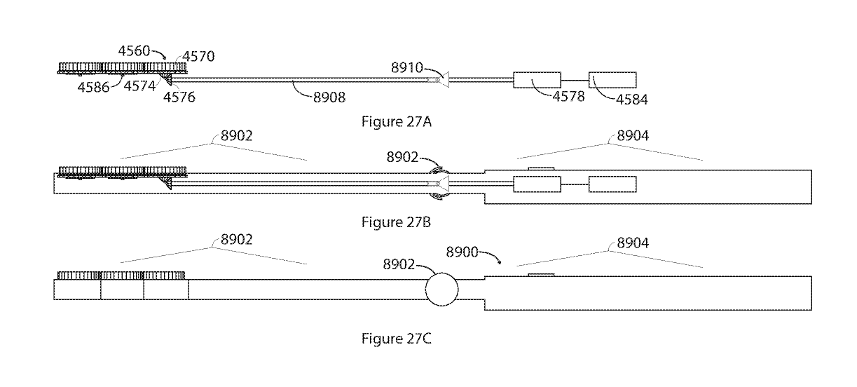

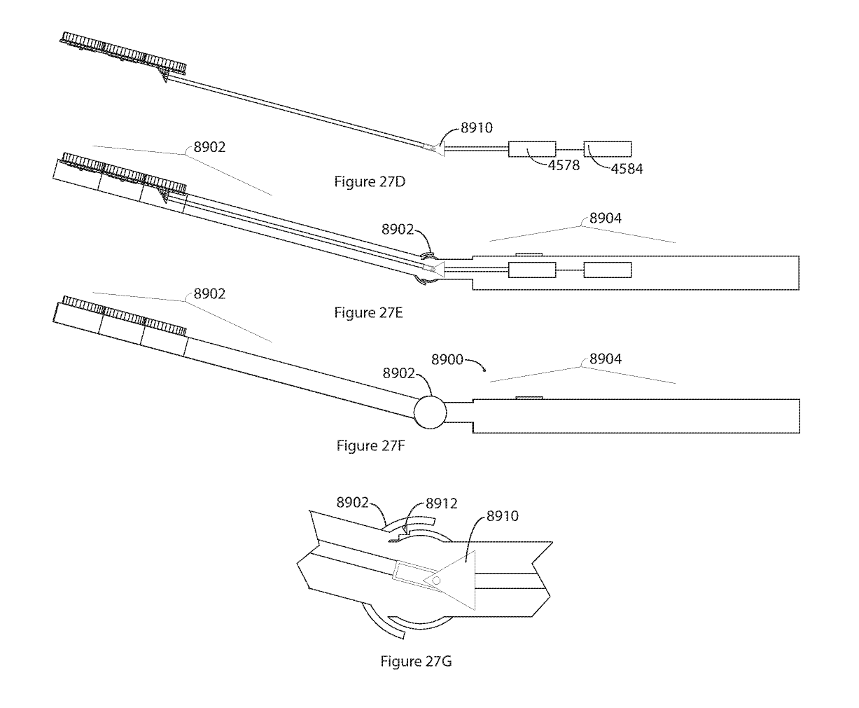

FIGS. 27A-G schematically illustrate handheld device 8900, or portions thereof, that includes positioning mechanism 8902 from various views according to one exemplary embodiment of the invention. As shown, handheld device 8900 includes handle portion 8904 operably connected to head portion 8906. Shaft 8908 operably connects motor component 4578 to rotational components 4560. In this exemplary embodiment, positioning mechanism 8902 includes universal joint 8910 operably connected to shaft 8908. Universal joint 8910 permits shaft 8908 to rotate in multiple selectable positions. Other positioning mechanism components are optionally utilized. Positioning mechanism 8902 also includes retaining mechanism 8912 (shown as a projection and corresponding selectable receiving areas). Retaining mechanism 8912 is configured to retain handle portion 8904 and head portion 8906 positioned relative to one another when a given position is selected.

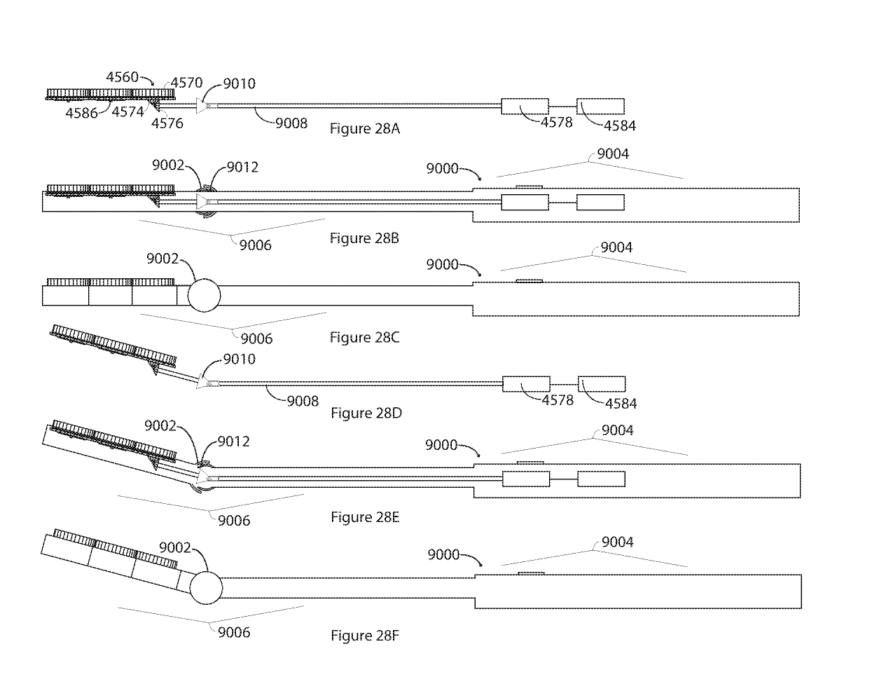

FIGS. 28A-F schematically illustrate handheld device 9000, or portions thereof, that includes positioning mechanism 9002 from various views according to one exemplary embodiment of the invention. As shown, handheld device 9000 includes handle portion 9004 operably connected to head portion 9006. Shaft 9008 operably connects motor component 4578 to rotational components 4560. In this exemplary embodiment, positioning mechanism 9002 includes universal joint 9010 operably connected to shaft 9008. Universal joint 9010 permits shaft 9008 to rotate in multiple selectable positions. Other positioning mechanism components are optionally utilized. Positioning mechanism 9002 also includes retaining mechanism 9012 (shown as a projection and corresponding selectable receiving areas). Retaining mechanism 9012 is configured to retain handle portion 9004 and head portion 9006 positioned relative to one another when a given position is selected.

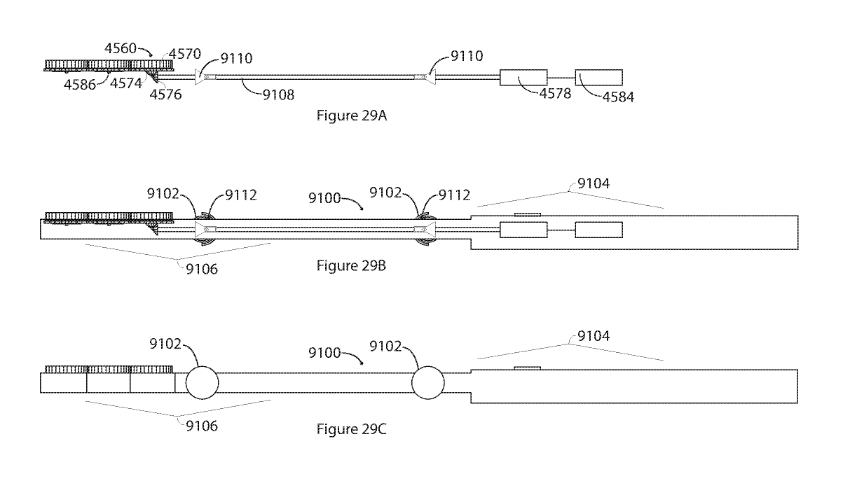

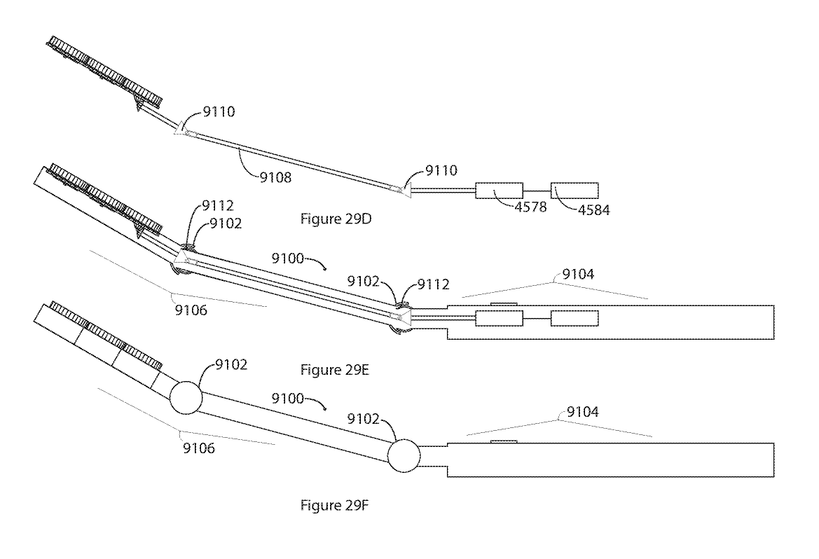

FIGS. 29A-F schematically illustrate handheld device 9100, or portions thereof, that includes positioning mechanisms 9102 from various views according to one exemplary embodiment of the invention. As shown, handheld device 9100 includes handle portion 9104 operably connected to head portion 9106. Shaft 9108 operably connects motor component 4578 to rotational components 4560. In this exemplary embodiment, positioning mechanism 9102 includes universal joint 9110 operably connected to shaft 9108. Universal joint 9110 permits shaft 9108 to rotate in multiple selectable positions. Other positioning mechanism components are optionally utilized. Positioning mechanism 9102 also includes retaining mechanism 9112 (shown as a projection and corresponding selectable receiving areas). Retaining mechanism 9112 is configured to retain handle portion 9104 and head portion 9106 positioned relative to one another when a given position is selected.

Device components (e.g., rotary units, rotary mechanisms, drive mechanism components, gear components, shafts, rotational components, device housings, doors, support structures, etc.) are optionally formed by various fabrication techniques or combinations of such techniques including, e.g., cast molding, stamping, machining, embossing, extrusion, engraving, injection molding, etching (e.g., electrochemical etching, etc.), or other techniques. These and other suitable fabrication techniques are generally known in the art and described in, e.g., Molinari et al. (Eds.), Metal Cutting and High Speed Machining, Kluwer Academic Publishers (2002), Altintas, Manufacturing Automation: Metal Cutting Mechanics, Machine Tool Vibrations, and CNC Design, Cambridge University Press (2000), Stephenson et al., Metal Cutting Theory and Practice, Marcel Dekker (1997), Fundamentals of Injection Molding, W. J. T. Associates (2000), Whelan, Injection Molding of Thermoplastics Materials, Vol. 2, Chapman & Hall (1991), Rosato, Injection Molding Handbook, 3^{rd} Ed., Kluwer Academic Publishers (2000), Fisher, Extrusion of Plastics, Halsted Press (1976), and Chung, Extrusion of Polymers: Theory and Practice, Hanser-Gardner Publications (2000), which are each incorporated by reference. Exemplary materials optionally used to fabricate device components include, e.g., metal, glass, wood, polymethylmethacrylate, polyethylene, polydimethylsiloxane, polyetheretherketone, polytetrafluoroethylene, polystyrene, polyvinylchloride, polypropylene, polysulfone, polymethylpentene, and polycarbonate, among many others. In certain embodiments, following fabrication, device components are optionally further processed, e.g., by painting, coating surfaces with a hydrophilic coating, a hydrophobic coating, or the like.

Exemplary rotary units, rotational mechanisms, related applications, and other aspects, which are optionally adapted, e.g., for use with the rotary units and rotational mechanisms described herein are also described in, e.g., U.S. patent application Ser. No. 12/577,326, entitled “ROTARY UNITS, MECHANISMS, AND RELATED DEVICES”, filed on Oct. 12, 2009 (now U.S. Pat. No. 8,152,679, issued Apr. 10, 2012), U.S. Provisional Patent Application No. 61/104,748, entitled “ROTARY UNITS, MECHANISMS, AND RELATED DEVICES”, filed on Oct. 12, 2008, International Application No. PCT/US2009/060386, entitled “ROTARY UNITS, MECHANISMS, AND RELATED DEVICES”, filed on Oct. 12, 2009, U.S. Provisional Patent Application No. 61/365,290, entitled “ROTARY UNITS, MECHANISMS, AND RELATED DEVICES”, filed on Jul. 16, 2010, U.S. patent application Ser. No. 13/184,332, entitled “ROTARY UNITS, MECHANISMS, AND RELATED DEVICES”, filed on Jul. 15, 2011, U.S. patent application Ser. No. 13/218,145, entitled “ROTARY UNITS, MECHANISMS, AND RELATED DEVICES”, filed on Aug. 25, 2011, U.S. patent application Ser. No. 13/219,683, entitled “ROTARY UNITS, MECHANISMS, AND RELATED DEVICES”, filed on Aug. 28, 2011, U.S. patent application Ser. No. 13/221,890, entitled “ROTARY UNITS, MECHANISMS, AND RELATED DEVICES”, filed on Aug. 30, 2011, and U.S. patent application Ser. No. 13/423,413, entitled “ROTARY UNITS, MECHANISMS, AND RELATED DEVICES”, filed on Mar. 19, 2012, which are each incorporated herein by reference in their entirety for all purposes.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A rotary mechanism, comprising:
at least first and second rotary units that each comprise at least one rotational component, which rotational component comprises at least a first portion and is configured to comprise at least a second portion, wherein the first and/or second portion comprises at least one attachment component or portion thereof that is configured to reversibly attach the first and second portions to one another, and wherein at least one of the second portions comprises at least one implement;
at least a first counter-rotational mechanism that operably engages at least the first portions of the first and second rotary units; and,
at least one drive mechanism component or a portion thereof that operably engages one or more of the first and second rotary units and/or the first counter-rotational mechanism, which drive mechanism component or portion thereof is configured to effect movement of at least the first portions of the first and second rotary units and first counter-rotational mechanism such that at least the first portion of the first rotary unit rotates in a first direction and at least the first portion of the second rotary unit rotates in a second direction.

2. The rotary mechanism of claim 1, comprising more than two rotary units.

3. The rotary mechanism of claim 1, wherein the rotational components or portions thereof are configured to rotate substantially non-concentric relative to one another.

4. The rotary mechanism of claim 1, wherein the rotational components each comprise at least one gear component, wherein the gear component of at least a first rotational component operably engages the gear component of at least a second rotational component.

5. The rotary mechanism of claim 1, comprising the second portions.

6. The rotary mechanism of claim 1, wherein each of the second portions comprises one or more implements.

7. The rotary mechanism of claim 1, wherein at least one of the second portions lacks one or more implements.

8. The rotary mechanism of claim 1, wherein at least one of the first and second portions comprises at least one retaining mechanism or portion thereof that is configured to retain the second portion in position relative to the first portion when the second portion is reversibly attached to the first portion.

9. The rotary mechanism of claim 1, wherein at least one of the rotational components comprises at least one resilient coupling that resiliently couples at least a first segment of the rotational component to at least a second segment of the rotational component.

10. The rotary mechanism of claim 1, wherein the attachment component or portion thereof comprises latch components that are configured to engage one another to reversibly attach the first and second portions to one another.

11. The rotary mechanism of claim 1, wherein the attachment component or portion thereof comprises compression mechanism components that are configured to engage one another to reversibly attach the first and second portions to one another.

12. The rotary mechanism of claim 1, wherein the drive mechanism component or portion thereof comprises at least one shaft component that operably engages at least the rotary mechanism or a portion thereof.

13. A dental device comprising the rotary mechanism of claim 1.

14. The rotary mechanism of claim 1, wherein at least a first rotational component is configured to rotate at least 360° around a first rotational axis and wherein at least a second rotational component is configured to rotate at least 360° around a second rotational axis.

15. The rotary mechanism of claim 1, wherein at least the first counter-rotational mechanism comprises at least a first gear component disposed on the first portion of a first rotational component and at least a second gear component disposed on the first portion of a second rotational component, wherein the first and second gear components operably engage one another such that when the first gear component rotates in the first direction, the first portion of the first rotational component rotates in the first direction and the second gear component and the first portion of a second rotational component rotate in the second direction.

16. A rotary mechanism, comprising:
at least first and second rotary units that each comprise at least one rotational component, wherein one or more of the rotational components comprises at least a first portion and is configured to comprise at least a second portion, wherein the first and/or second portion comprises at least one attachment component or portion thereof that is configured to reversibly attach the first and second portions to one another, and wherein at least one of the rotational components or portion thereof comprises at least one implement;
at least a first counter-rotational mechanism that operably engages at least the rotational components or portion thereof of the first and second rotary units; and,
at least one drive mechanism component or a portion thereof that operably engages one or more of the first and second rotary units and/or the first counter-rotational mechanism, which drive mechanism component or portion thereof is configured to effect movement of at least the rotational components or portion thereof and the first counter-rotational mechanism such that the rotational component or portion thereof of the first rotary unit rotates in a first direction and the rotational component or portion thereof of the second rotary unit rotates in a second direction.

17. A handheld device, comprising:
a head portion comprising at least one rotary mechanism that comprises at least two rotational components, wherein each of the rotational components comprises at least a first portion and is configured to comprise at least a second portion, wherein the first and/or second portion comprises at least one attachment component or portion thereof that is configured to reversibly attach the first and second portions to one another, wherein at least a first rotational component is configured to rotate at least partially around a first rotational axis, wherein at least a second rotational component is configured to rotate at least partially around a second rotational axis, and wherein at least one of the second portions comprises at least one implement;
at least one drive mechanism component or portion thereof that operably engages, or is configured to operably engage, at least the rotary mechanism, which drive mechanism component or portion thereof is configured to effect rotation of at least a portion of the first rotational component at least partially around the first rotational axis in a first direction and at least a portion of the second rotational component at least partially around the second rotational axis in a second direction; and,
a handle portion operably connected or connectable to the head portion.

18. The handheld device of claim 17, wherein the handle portion comprises at least part of the drive mechanism component or portion thereof.

19. The handheld device of claim 17, wherein the head and handle portions are detachable from one another.

20. A tooth brushing device or a cleaning device comprising the handheld device of claim 17.
